(19) United States
(12) Patent Application Publication
(10) Pub. No.: US 2024/0027191 A1
(43) Pub. Date: Jan. 25, 2024

(54) Optical Triangulation Sensor

(71) Applicant: Leuze electronic GmbH + Co. KG, Owen/Teck (DE)

(72) Inventors: Markus Butzbach, Wiesbaden (DE); Siegfried Fauth, Kirchheim/Teck (DE)

(21) Appl. No.: 18/221,392

(22) Filed: Jul. 13, 2023

(30) Foreign Application Priority Data
Jul. 21, 2022 (EP) 22186151.1

(51) Int. Cl. G01C 3/10

(52) U.S. Cl. CPC G01C 3/10

(57) ABSTRACT

The optical triangulation sensor is used for detecting objects in a monitoring area and comprises a transmitter emitting transmitted light beams and a receiver assembly with at least two receivers arranged side by side in a triangulation direction at a distance from the transmitter. Transmitted light beams of the transmitter are reflected by an object in the monitoring area and guided to the receiver assembly as received light beams. The optical triangulation sensor comprises a control and evaluation unit in which an object detection signal is generated depending on receiver signals of the receivers. There is a gap between the receivers. A receiving optical system is arranged upstream of the receiver assembly, by means of which system the received light beams are split into two received light bundles, wherein the spacing of the received light bundles is adapted to the size of the gap.

### CROSS REFERENCE TO RELATED APPLICATIONS

This application claims the priority of EP 22186151.1 filed on 2022 Jul. 21; this application is incorporated by reference herein in its entirety.

### BACKGROUND

The invention relates to an optical triangulation sensor according to the preamble of claim 1.

Such optical triangulation sensors operate according to the triangulation principle. Accordingly, the transmitter and receiver assembly of the optical triangulation sensor form a triangulation assembly. In this triangulation assembly, the receivers of the receiver assembly are arranged side by side in a triangulation direction at a distance from the transmitter. The triangulation direction runs transversely, advantageously perpendicular to the beam axis of the transmitted light beams emitted by the transmitter.

To detect an object in the monitoring area, the transmitter's transmitted light beams strike this object, which guides them back to the receiver assembly as received light beams. The strike location of the light spot of the received light beams on the receiver assembly depends on the distance of the object to the optical triangulation sensor. At short distances, the received light beams predominantly strike a first receiver of the receiver assembly, which receiver forms a near element. At long distances, the received light beams predominantly strike the second receiver of the receiver assembly, which receiver forms a far element.

An object detection signal is generated in the control and evaluation unit from the ratio of the receiver signals.

Usually, the difference of the received signals of the receivers, i.e. of the near and far elements, is formed, wherein the object detection signal is generated from this difference. Typically, the difference of the received signals is evaluated with a threshold value forming a switching threshold. This defines a sensing range, i.e. a detection distance, which limits a sensing area.

If the light spot of the received light beams predominantly strikes the near element, the object is located within the sensing area. If the light spot of the received light beams predominantly strikes the far element, the object is located outside the sensing area in a background area.

FIG. 3 shows an example of the differential signals of an optical triangulation sensor in dependence on the object distance, wherein the depicted curve a is obtained from the detection of a bright, highly reflective object and the depicted curve b is obtained from a weakly reflective object.

The same factor lies between the two curves at every distance, namely the ratio of the object remissions. The zero crossing of the differential signal is at the same distance for both curves. At this point, regardless of the total amount of light collected, the near element and the far element provide the same signal. If the received signals of the near and far elements are amplified equally, the light spot of the received light beams will sit centered on the dividing line between the near and far elements.

This type of evaluation has the great advantage that objects located further away from the optical triangulation sensor always produce a light spot with the center of gravity on the far element, so that the differential signal always becomes negative. This means that objects in the background can be reliably suppressed, regardless of the object remission, i.e. a background suppression takes place.

If there is no object in the monitoring area, i.e. no light strikes the receivers, the evaluated differential signal is 0. Therefore, in order to detect an object in the monitoring area without ambiguities, the threshold value used for generating the object detection signal is usually not at the zero point of the differential signal.

In FIG. 3, the threshold value, i.e. the switching threshold, is marked thr.

This selection of the switching threshold results in a slightly different detection distance for light and dark objects. This deviation of the detection distance is called black-white error and is marked e in FIG. 3.

Ideally, the black-white error is as small as possible, since then all objects, regardless of their remission, are detected up to the same detection distance. As shown in FIG. 3, one prerequisite for this is that the distance characteristic runs as steeply as possible in the area of the switching threshold.

For sensors with background suppression, it is advantageous for robust switching behavior with low black-white error if the gap between the near and far elements is as small as possible. In this case, the transition between the near and far area is the sharpest since the migration of the light spot of the received light beams from the near to the far element or vice versa is the fastest. This results in a robust switching behavior of the optical triangulation sensor and a minimal black-white error.

Receiving lines with multiple pixels or double photodiodes are usually used as receivers. In these components, the individual photodiodes are physically located on the same semiconductor substrate and are only electrically separated. This allows distances of a few micrometers between individual receivers.

Compared to standard photodiodes, these receiver components are very expensive due to the more complex semiconductor processes coupled with lower quantities. Furthermore, the components are significantly larger than standard photodiodes. This can be an obstacle in the miniaturization of such sensors.

When using low-cost standard photodiodes for the near and far elements, the problem arises that the gap between the elements becomes much larger than with the aforementioned prior art solutions. When using SMD photodiodes, the distance between the receiver surfaces can grow to >1 mm due to the distances to the housing edge. Even if the photodiodes are contacted directly on the printed circuit board (chip-on-board technology), distances of several 100 μm between the diodes must be expected.

If, in such a system, a receiving optical system is used which images the received light as sharply as possible in the receiver plane, this can lead to undefined switching behavior, since, during the transition from one receiving element to the other, the received light falls completely into the gap between the receiving elements and thus no defined received signal is generated.

In order to compensate for the gap between the receiving diodes and still maintain the functionality of an optical triangulation sensor with background suppression, it is conceivable to defocus the received light spot and thus enlarge it in the receiver plane in such a way that both receivers are irradiated by part of the light spot during the transition from near to far element (or vice versa).

Increasing the size of the received light spot when there is a gap between receivers results in less robust switching behavior and increased black-white error, since the transition of the received light spot from the near to the far element or vice versa occurs much more slowly. In addition, the maximum range of the optical triangulation sensor is reduced because much of the light collected by the receiving optical system lands in the gap between the receivers and does not contribute to signal generation.

### SUMMARY

The optical triangulation sensor (1) according to the invention is used for detecting objects (11) in a monitoring area and comprises a transmitter (6) emitting transmitted light beams (5) and a receiver assembly with at least two receivers (8, 9) arranged side by side in a triangulation direction at a distance from the transmitter (6). Transmitted light beams (5) of the transmitter (6) are reflected by an object (11) in the monitoring area and guided to the receiver assembly as received light beams (12). The optical triangulation sensor (1) comprises a control and evaluation unit in which an object detection signal is generated depending on receiver signals of the receivers (8, 9). There is a gap (13) between the receivers (8, 9). A receiving optical system (10) is arranged upstream of the receiver assembly, by means of which system the received light beams (12) are split into two received light bundles (14, 15), wherein the spacing of the received light bundles (14, 15) is adapted to the size of the gap (13).

### DETAILED DESCRIPTION

The object of the invention is to provide an optical triangulation sensor with high functionality while using inexpensive standard components.

The features of claim 1 are intended to provide a solution to this object. Advantageous embodiments of the invention and appropriate further developments are described in the dependent claims.

The optical triangulation sensor according to the invention is used for detecting objects in a monitoring area and comprises a transmitter emitting transmitted light beams and a receiver assembly with at least two receivers arranged side by side in a triangulation direction at a distance from the transmitter. Transmitted light beams of the transmitter are reflected by an object in the monitoring area and guided to the receiver assembly as received light beams. The optical triangulation sensor comprises a control and evaluation unit in which an object detection signal is generated depending on receiver signals of the receivers. There is a gap between the receivers. A receiving optical system is arranged upstream of the receiver assembly, by means of which system the received light beams are split into two received light bundles, wherein the spacing of the received light bundles is adapted to the size of the gap.

With the optical triangulation sensor according to the invention, reliable, safe object detection is made possible independently of the remission of the objects to be detected, i.e. only a small black-white error occurs in the object detections.

According to the invention, this is achieved by arranging the at least two receivers of the receiver assembly stationary relative to one another in the optical triangulation sensor in such a way that there is a defined gap between them. According to the invention, a receiving optical system adapted for this purpose is provided, which splits received light beams reflected back from an object into two received light bundles, the spacing of which is adapted to the size of the gap between the two receivers.

Advantageously, the spacing of the received light bundles at the location of the receiver assembly corresponds at least approximately to the size of the gap.

This ensures that at any object distance, the light spot of at least one received light bundle always strikes at least one receiver, which is an essential prerequisite for a low black-white error.

In addition, the receiving optical system adapted to the receiver assembly allows the light spots of the received light bundles to be selected small, which further keeps the black-white error of the optical triangulation sensor low.

Another significant advantage of the optical triangulation sensor according to the invention is that the receivers can be arranged in such a way that there is a gap between them without this causing a significant worsening of the black-white error. This is based on the fact that the gap between the receivers is largely compensated for by the receiving optical system, which splits the received light beams into two received light bundles.

The receiver assembly according to the invention can then be formed by receivers in the form of photodiodes, as standard receiving elements that can be obtained at low cost, which helps to reduce the manufacturing costs of the optical triangulation sensor.

Advantageously, the components of the optical triangulation sensor are accommodated in a housing in which there is a printed circuit board on which the receivers, which may be designed as photodiodes, are arranged.

Advantageously, the printed circuit board can be assembled in a conventional SMD (surface mounted device) process.

A particularly efficient manufacturing process and compact design of the optical triangulation sensor results when the transmitter is also arranged on the printed circuit board.

The transmitter can be formed by a light emitting diode or a laser diode.

According to a structurally advantageous embodiment, there is a diaphragm in the area of the gap between the receivers.

Expediently, the diaphragm can cover edge areas of the receiver assembly.

With the diaphragm, the gap between the receivers can be precisely specified, regardless of mounting tolerances of the receivers of the receiver assembly.

According to an advantageous embodiment, the receiving optical system has two partial lenses with different optical axes.

According to an alternative embodiment, the receiving optical system has optical surfaces tilted with respect to one another.

Furthermore, the receiving optical system can have an assembly of microlenses or microprisms.

Finally, the receiving optical system can form a diffractive element.

The optical triangulation sensor according to the invention may generally have more than two receivers, wherein two adjacent receivers are always separated by a gap, wherein advantageously the gaps are at least approximately equal in size. For these embodiments, as well, it is sufficient if the receiving optical system splits the received light beams into two received light bundles whose spacing is adapted to the size of the gap.

In this embodiment, a plurality of receivers can be connected together and interconnected to form a near element to which received light from an object in a near area is guided. Likewise, several receivers can be interconnected to form a far element.

According to an advantageous embodiment, the object detection signal is formed from a ratio of the received signals of the receivers.

This evaluation generally enables object detection within a sensing area limited by a sensing range. In addition, background suppression is implemented in such a way that objects at distances greater than the sensing range are not detected.

For example, the ratio formed is the quotient of the received signals of the near and far elements, wherein both the near element and the far element can consist of one or a plurality of receivers.

Alternatively, the object detection signal is formed from the difference of the received signals of the receivers.

Both variants are particularly suitable if the receiver assembly has exactly two receivers.

Advantageously, the difference of the received signals is evaluated with a threshold value.

The threshold defines the sensing range which limits the sensing area within which objects are captured and separates said sensing area from a background area.

By the splitting of the received light beams according to the invention into two received light bundles by means of the receiving optical system and by adapting the spacing of the received light bundles to the gap between the receivers, a high steepness of the differential signal is obtained in the area adjacent to the zero crossing despite the gap, thus reducing the black-white error of the optical triangulation sensor.

### BRIEF DESCRIPTION OF THE DRAWINGS

The invention is explained below on the basis of the drawings: The Figures show:

FIG. 1: A schematic representation of a prior art optical triangulation sensor for an object in a near area.

FIG. 2: An assembly according to FIG. 1 in the case of an object in a far area.

FIG. 3: Distance dependence of the differential signal of the receiving elements of the optical triangulation sensor according to FIGS. 1 and 2 for two objects with different remissions.

FIG. 4: First embodiment example of the optical triangulation sensor according to the invention.

FIG. 5: Second embodiment example of the optical triangulation sensor according to the invention.

FIG. 6: Light spot distribution of two received light bundles on the receiver assembly of the optical triangulation sensor according to FIG. 4 or 5.

FIG. 7: Variant of the embodiment according to FIG. 4.

### DETAILED DESCRIPTION OF THE PREFERRED EMBODIMENTS

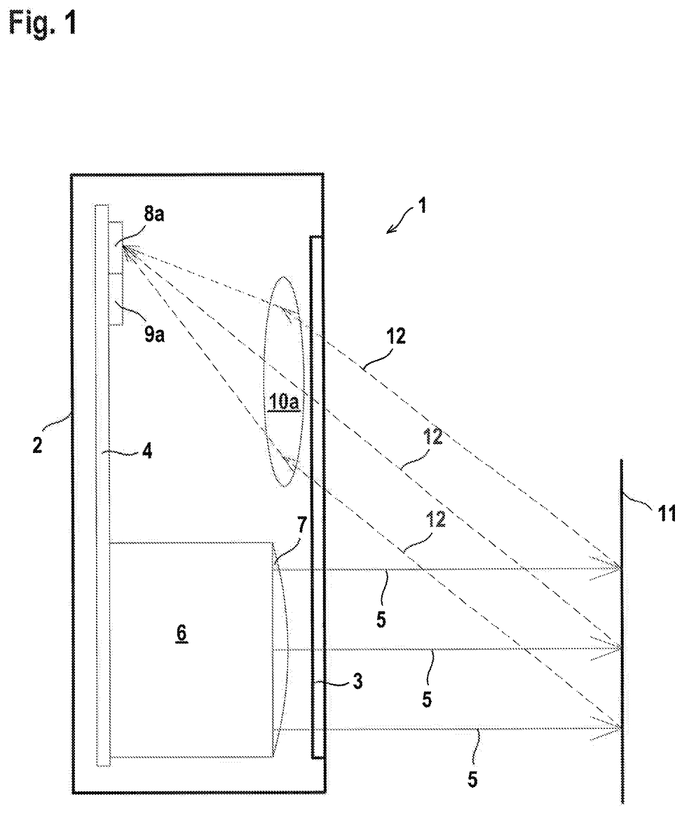

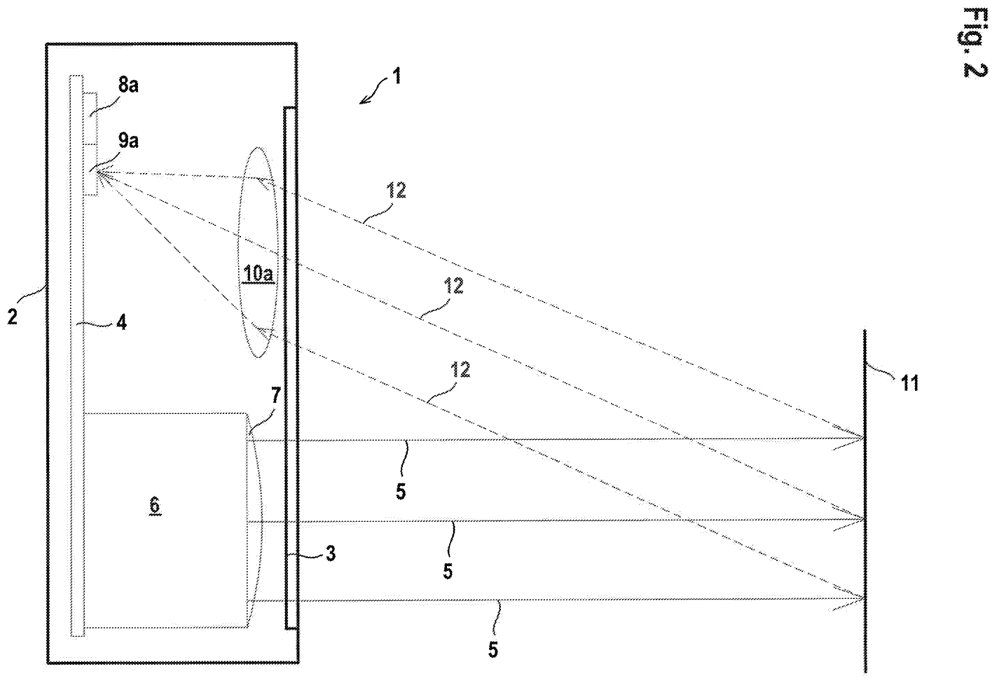

FIGS. 1 and 2 show a prior art optical triangulation sensor 1. The components of the optical triangulation sensor 1 are integrated in a housing 2 with opaque walls. A translucent front window 3 is located in the front wall of the housing 2.

A printed circuit board 4 is arranged in a stationary manner in the housing 2. Mounted on the printed circuit board 4 is a transmitter 6 emitting transmitted light beams 5, downstream of which is a beam-forming optical system 7. Furthermore, a receiver assembly with two receiving elements 8a, 9a is arranged on the printed circuit board 4. The receiving elements 8a, 9a form a double diode arranged on a semiconductor substrate. The receiving elements 8a, 9a adjoin each other with almost no gaps.

The receiver assembly forms a triangulation assembly in such a way that the receiving elements 8a, 9a are arranged side by side in a triangulation direction running transversely to the beam axis of the transmitted light beams 5 and at a distance from the transmitter 6.

Components of a control and evaluation unit are integrated on the printed circuit board 4 or a further printed circuit board. The control and evaluation unit is used to control the transmitter 6 and the receiving elements 8a, 9a. In addition, receiving signals of the receiving elements 8a, 9a are evaluated in the control and evaluation unit to generate an object detection signal.

A receiving optical system 10a in the form of a lens is assigned to the receiver assembly.

To detect an object 11 in a monitoring area, the transmitter 6 emits transmitted light beams 5 which are guided through the front window 3 into the monitoring area. The transmitted light beams 5 are diffusely reflected at the object 11 and are guided back to the optical triangulation sensor 1 as received light beams 12.

The received light beams 12 are guided through the front window 3 and guided onto the receiver plane of the receiving elements 8a, 9a by means of the lens.

At a short object distance, the received light beams 12 focused by the receiving optical system 10a predominantly strike the receiving element 8a which forms a near element (FIG. 1). At a large object distance, the received light beams 12 predominantly strike the receiving element 9a which forms a far element (FIG. 2).

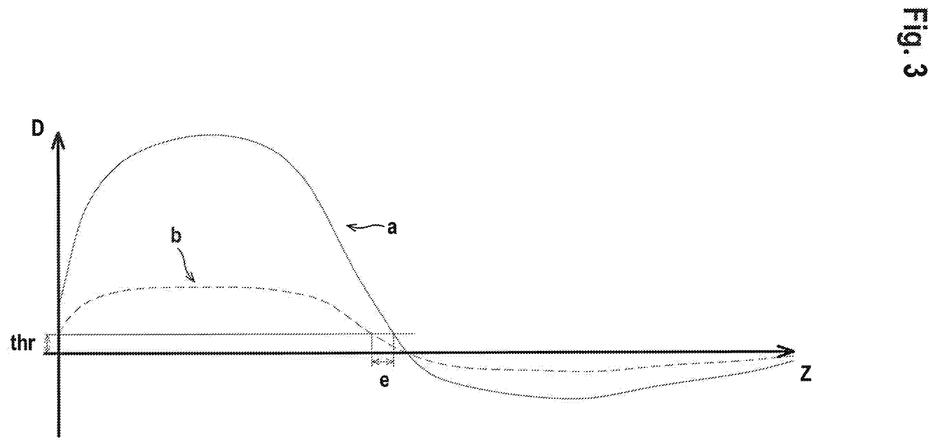

The difference between the received signals of the near and far elements is formed in the evaluation unit. The dependence of the differential signal D formed in this way as a function of the object distance z is shown in FIG. 3. FIG. 3 shows the differential signal D for the detection of an object 11 with high remission (curve a) and for a detection of an object 11 with low remission (curve b).

To generate the object detection signal, the differential signal D is evaluated in the evaluation unit with a threshold value thr forming a switching threshold. A sensing range (detection distance) is defined by the position of the zero crossing of the differential signal D and the threshold value thr, which sensing range limits a sensing area (detection range).

If the threshold evaluation results in a value of the differential signal D greater than thr, the object 11 is considered to be detected within the sensing area. Values of the differential signal D below the threshold value thr are suppressed as background signals, i.e. background suppression takes place with the optical triangulation sensor 1.

Since the signal curves of the differential signal D are different for objects 11 with different remissions, the differential signals D reach the threshold value thr at different object distances, i.e. there is a black-white error in the object detection (marked as e in FIG. 3).

A sensing range adjustment is possible by changing the triangulation conditions, which shifts the object distance at which the zero crossing of the differential signal D occurs. This is advantageously possible by mechanically shifting the position of the receiving optical system or receiver assembly in the triangulation direction.

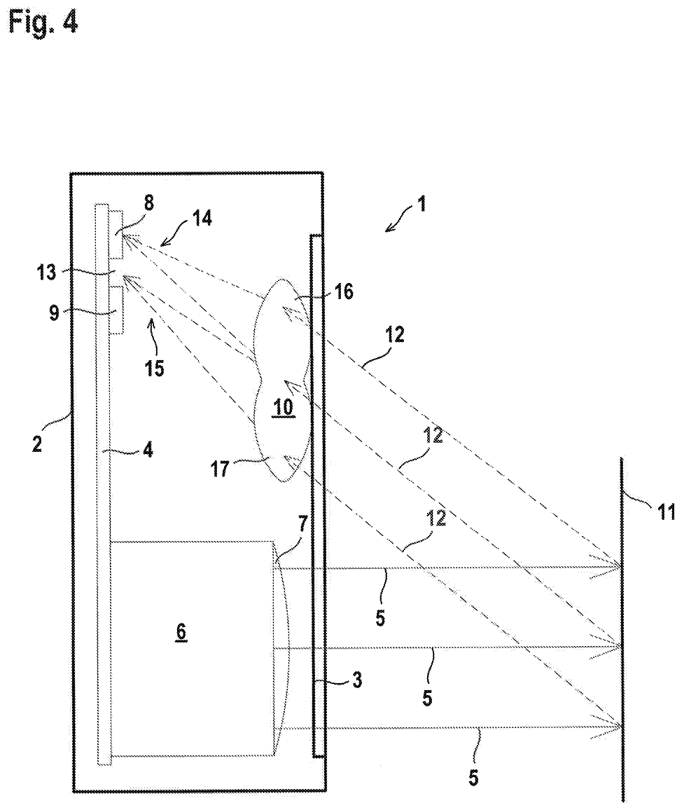

FIG. 4 shows a first embodiment example of the optical triangulation sensor 1 according to the invention. This optical triangulation sensor 1 according to the invention differs from the prior art optical triangulation sensor 1 of FIGS. 1 and 2 with respect to the design of the receiver assembly and the receiving optical system 10.

The optical triangulation sensor 1 shown in FIG. 4 has a receiver assembly with two receivers 8, 9 which are mounted on the printed circuit board 4 in such a way that there is a defined gap 13 between them.

The receivers 8, 9 are designed in the form of photodiodes, i.e. in contrast to the receiving elements 8a, 9a of the optical triangulation sensor 1 according to FIGS. 1 and 2, the receivers 8, 9 of the optical triangulation sensor 1 according to the invention consist of low-cost standard components. Advantageously, the receivers 8, 9 are assembled on the printed circuit board 4 by means of an SMD process.

Furthermore, the receiving optical system 10 according to the invention is designed to split the received light beams 12 into two received light bundles 14, 15.

The spacing of the received light bundles 14, 15 is adapted to the size of the gap 13. Advantageously, the spacing of the received light bundles 14, 15 in the receiver plane of the receiver assembly corresponds at least approximately to the size of the gap 13. This ensures that at least one received light bundle 14, 15 always strikes at least one receiver 8, 9, regardless of the object distance z, so that reliable object detection is guaranteed for any object distances.

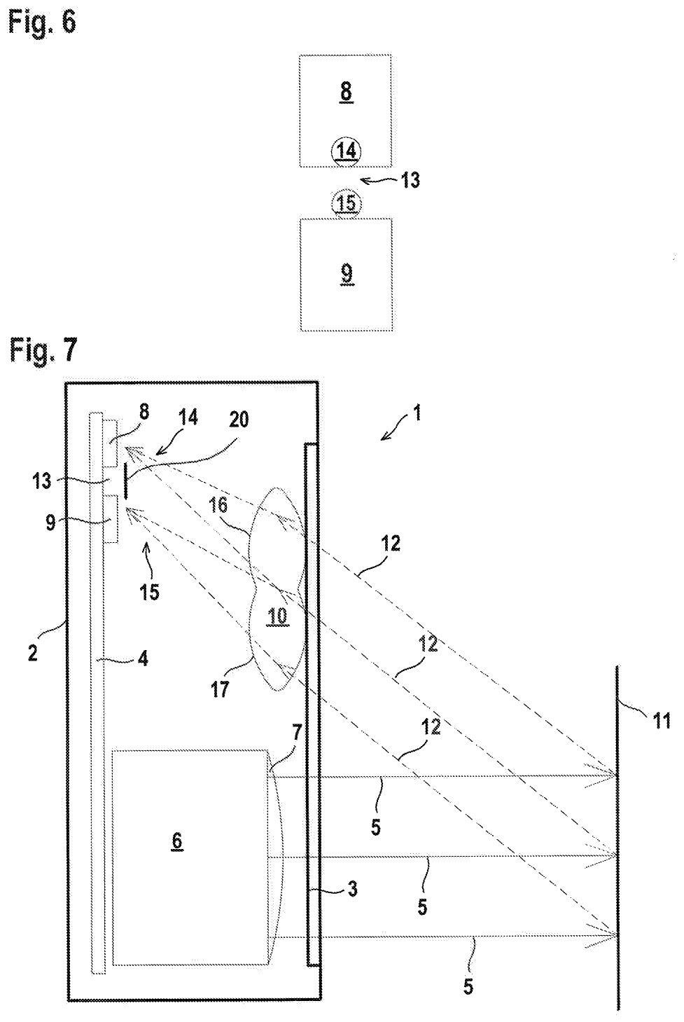

This is illustrated in FIG. 6, which shows the top view of the light-sensitive surfaces of the receivers 8, 9 with the light spots of the received light beams 12. As FIG. 6 shows, the light spots of the received light beams 12 are smaller than the light-sensitive areas of the receivers 8, 9. This is an essential prerequisite for error-free reliable object detection.

In particular, this improves the switching behavior of the optical triangulation sensor 1.

The differential signals D are again evaluated with the threshold value thr to generate the object detection signal. The receiver assembly according to the invention in combination with the receiving optical system 10 according to the invention results in a steep curve of the distance signals D in the upper limit range of the sensing range, which results in a comparatively low black-white error e when compared to the prior art optical triangulation sensor 1 (as illustrated in FIG. 3).

In the receiving optical system 10 of the optical triangulation sensor 1 shown in FIG. 4, the splitting of the received light beams 12 into two received light bundles 14, 15 is achieved by the fact that this receiving optical system 10 consists of two partial lenses 16, 17.

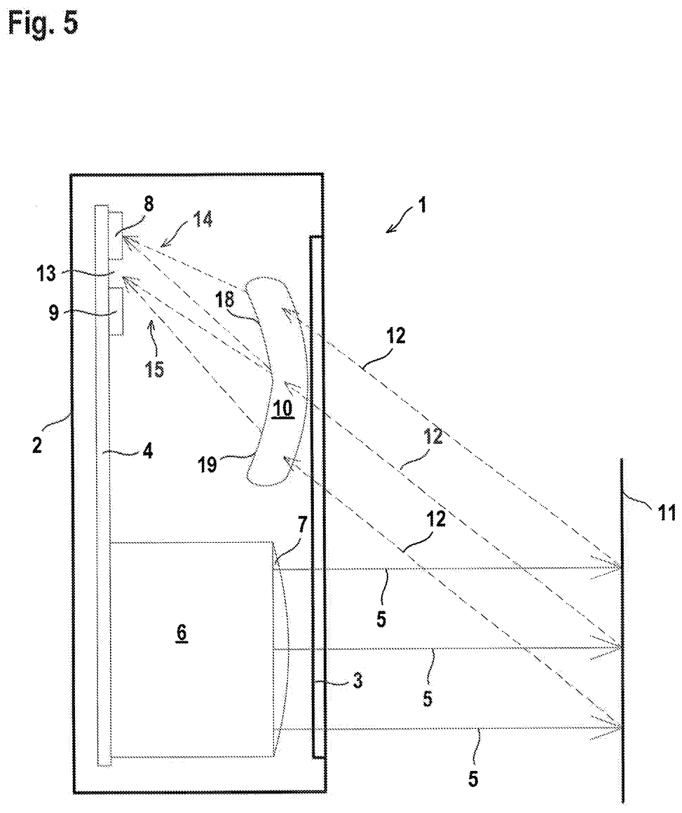

FIG. 5 shows a variant of the embodiment according to FIG. 4, wherein this embodiment differs only with regard to the design of the receiving optical system 10. In the receiving optical system 10 shown in FIG. 5, the splitting of the received light beams 12 into the two received light bundles 14, 15 is achieved by the fact that the receiving optical system 10 has two light exit surfaces 18, 19 running at an angle to one another.

FIG. 7 shows a further development of the embodiment according to FIG. 4. The embodiment shown in FIG. 7 differs from the embodiment shown in FIG. 4 only in that the gap 13 is covered by a diaphragm 20. In the present case, the diaphragm 20 also covers edge areas of the receivers 8, 9. The diaphragm 20 can be used to precisely specify the size of the gap area between the receivers 8, 9, wherein the diaphragm 20 can also be used to compensate for mounting tolerances of the mounting of the receivers 8, 9 on the printed circuit board 4. Of course, a diaphragm 20 can also be provided in the embodiment of FIG. 5.

### LIST OF REFERENCE NUMERALS

(1) Optical triangulation sensor
(2) Housing
(3) Front window
(4) Printed circuit board
(5) Transmitted light beams
(6) Transmitter
(7) Beam-forming optical system
(8) Receiver
(8a) Receiving element
(9) Receiver
(9a) Receiving element
(10) Receiving optical system
(10a) Receiving optical system
(11) Object
(12) Received light beams
(13) Gap
(14) Received light bundles
(15) Received light bundles
(16) Partial lenses
(17) Partial lenses
(18) Light exit surface
(19) Light exit surface
(20) Diaphragm
(D) Differential signal
(e) Black-white error
(thr) Threshold value
(z) Object distance

1. An optical triangulation sensor (1) for detecting objects (11) in a monitoring area, having a transmitter (6) emitting transmitted light beams (5), having a receiver assembly with at least two receivers (8, 9) arranged side by side in a triangulation direction at a distance from the transmitter (6), wherein transmitted light beams (5) from the transmitter (6) are reflected by an object (11) in the monitoring area and are guided to the receiver assembly as received light beams (12), and having a control and evaluation unit in which an object detection signal is generated depending on receiver signals of the receivers (8, 9), characterized in that there is a gap (13) between the receivers (8, 9), and in that a receiving optical system (10) is arranged upstream of the receiver assembly, by means of which system the received light beams (12) are split into two received light bundles (14, 15), wherein the spacing of the received light bundles (14, 15) is adapted to the size of the gap (13).

2. The optical triangulation sensor (1) according to claim 1, characterized in that its components are integrated in a housing (2) in which there is a printed circuit board (4) on which the receivers (8, 9) of the receiver assembly are arranged.

3. The optical triangulation sensor (1) according to claim 1, characterized in that the receivers (8, 9) of the receiver assembly are formed by photodiodes.

4. The optical triangulation sensor (1) according to claim 2, characterized in that the receivers (8, 9) are assembled on the printed circuit board (4) by means of an SMD process.

5. The optical triangulation sensor (1) according to claim 2, characterized in that the transmitter (6) is arranged on the printed circuit board (4).

6. The optical triangulation sensor (1) according to claim 1, characterized in that there is a diaphragm (20) in the area of the gap (13) between the receivers (8, 9).

7. The optical triangulation sensor (1) according to claim 6, characterized in that the diaphragm (20) covers edge regions of the receivers (8, 9).

8. The optical triangulation sensor (1) according to claim 1, characterized in that the receiving optical system (10) has two partial lenses (16, 17) with different optical axes.

9. The optical triangulation sensor (1) according to claim 1, characterized in that the receiving optical system (10) has optical surfaces tilted with respect to one another.

10. The optical triangulation sensor (1) according to claim 1, characterized in that the receiving optical system (10) has an assembly of microlenses or microprisms.

11. The optical triangulation sensor (1) according to claim 1, characterized in that the receiving optical system (10) forms a diffractive element.

12. The optical triangulation sensor (1) according to claim 1, characterized in that the spacing of the received light bundles (14, 15) at the location of the receiver assembly corresponds at least approximately to the size of the gap (13).

13. The optical triangulation sensor (1) according to claim 1, characterized in that the object detection signal is formed from a ratio of the received signals of the receivers (8, 9).

14. The optical triangulation sensor (1) according to claim 13, characterized in that the object detection signal is formed from the difference of the received signals of the receivers (8, 9).

15. The optical triangulation sensor (1) according to claim 14, characterized in that the difference of the received signals is evaluated with a threshold value (thr).
